(19) United States
(12) Patent Application Publication
(10) Pub. No.: US 2026/0082390 A1
(43) Pub. Date: Mar. 19, 2026

(54) POWER MODE SELECTION FOR SMALL DATA TRANSMISSION

(71) Applicant: QUALCOMM Incorporated, San Diego, CA (US)

(72) Inventors: Yung-Yih JIAN, Campbell, CA (US); Sai Laxman SAMBARAJU, Hyderabad (IN); Nazmul ISLAM, Littleton, MA (US); Chun-Hao HSU, San Jose, CA (US)

(21) Appl. No.: 18/890,720

(22) Filed: Sep. 19, 2024

(51) Int. Cl. H04W 72/23

(52) U.S. Cl. CPC H04W 72/23

(57) ABSTRACT

Methods, systems, and devices for wireless communications are described. A user equipment (UE) may transmit, while operating in a radio resource control (RRC) inactive mode, a first message initiating a small data transmission (SDT) between the UE and a network entity. The UE may obtain a modulation and coding scheme (MCS) index, a physical downlink control channel (PDCCH) code rate, or both based on initiating the SDT and based on monitoring a PDCCH associated with the SDT. The UE may perform the SDT according to a first power mode, where the first power mode may be selected from multiple power modes based on the MCS index satisfying a MCS threshold associated with the first power mode, based on the PDCCH code rate satisfying a PDCCH code rate threshold associated with the first power mode, or both.

### TECHNICAL FIELD

The following relates to wireless communications, including power mode selection for small data transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Components within a wireless communication system may be coupled (for example, operatively, communicatively, functionally, electronically, and/or electrically) to each other.

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting, while operating in a radio resource control (RRC) inactive mode, a first message initiating a small data transmission (SDT) between the UE and a network entity, obtaining a modulation and coding scheme (MCS) index, a physical downlink control channel (PDCCH) code rate, or both based on initiating the SDT and based on monitoring a PDCCH associated with the SDT, and performing the SDT according to a first power mode, where the first power mode is selected from a set of multiple power modes based on the MCS index satisfying a MCS threshold associated with the first power mode, based on the PDCCH code rate satisfying a PDCCH code rate threshold associated with the first power mode, or both.

A UE for wireless communications is described. The UE may include one or more memories storing processor-executable code, and one or more processors coupled with (e.g., operatively, communicatively, functionally, electronically, or electrically) the one or more memories. The one or more processors may be individually or collectively operable to execute the code (e.g., directly, indirectly, after pre-processing, without pre-processing) to cause the UE to transmit, while operating in an RRC inactive mode, a first message initiating an SDT between the UE and a network entity, obtain an MCS index, a PDCCH code rate, or both based on initiating the SDT and based on monitoring a PDCCH associated with the SDT, and perform the SDT according to a first power mode, where the first power mode is selected from a set of multiple power modes based on the MCS index satisfying a MCS threshold associated with the first power mode, based on the PDCCH code rate satisfying a PDCCH code rate threshold associated with the first power mode, or both.

Another UE for wireless communications is described. The UE may include means for transmitting, while operating in an RRC inactive mode, a first message initiating an SDT between the UE and a network entity, means for obtaining an MCS index, a PDCCH code rate, or both based on initiating the SDT and based on monitoring a PDCCH associated with the SDT, and means for performing the SDT according to a first power mode, where the first power mode is selected from a set of multiple power modes based on the MCS index satisfying a MCS threshold associated with the first power mode, based on the PDCCH code rate satisfying a PDCCH code rate threshold associated with the first power mode, or both.

A non-transitory computer-readable medium storing code for wireless communications is described. The code may include may include instructions executable by at least one processor (e.g., directly, indirectly, after pre-processing, without pre-processing) to transmit, while operating in an RRC inactive mode, a first message initiating an SDT between the UE and a network entity, obtain an MCS index, a PDCCH code rate, or both based on initiating the SDT and based on monitoring a PDCCH associated with the SDT, and perform the SDT according to a first power mode, where the first power mode is selected from a set of multiple power modes based on the MCS index satisfying a MCS threshold associated with the first power mode, based on the PDCCH code rate satisfying a PDCCH code rate threshold associated with the first power mode, or both.

Some examples of the method, UEs, and non-transitory computer-readable medium described herein may further include operations, features, means, or instructions for monitoring for a downlink grant within a duration of a timer associated with reception of the PDCCH, where the first power mode may be selected from the set of multiple power modes based on monitoring for the downlink grant within the duration of the timer.

In some examples of the method, UEs, and non-transitory computer-readable medium described herein, the first power mode may be selected from the set of multiple power modes according to the PDCCH code rate based on failing to receive the downlink grant within the duration of the timer.

In some examples of the method, UEs, and non-transitory computer-readable medium described herein, the first power mode may be selected from the set of multiple power modes according to the PDCCH code rate and the MCS index based on receiving the downlink grant within the duration of the timer.

Some examples of the method, UEs, and non-transitory computer-readable medium described herein may further include operations, features, means, or instructions for determining one of a high-performance (HPM) synthesizer or a low-performance (LPM) synthesizer to use for the SDT based on whether reciprocal mixing may be detected at the UE, based on whether jamming at the UE may be detected, or both, where the first power mode may be selected based on the determination.

In some examples of the method, UEs, and non-transitory computer-readable medium described herein, the HPM synthesizer may be used for the SDT based on the reciprocal mixing being detected at the UE, based on the jamming being detected at the UE, or both.

Some examples of the method, UEs, and non-transitory computer-readable medium described herein may further include operations, features, means, or instructions for receiving control signaling allocating a zero-power channel state information reference signal (ZP-CSI-RS) within a window associated with the SDT, where determining one of the HPM synthesizer or the LPM synthesizer may be based on measuring the ZP-CSI-RS.

Some examples of the method, UEs, and non-transitory computer-readable medium described herein may further include operations, features, means, or instructions for measuring a reference signal received power of a channel between the UE and the network entity serving the UE, where transmitting the first message may be based on the reference signal received power of the channel satisfying a reference signal received power threshold.

In some examples of the method, UEs, and non-transitory computer-readable medium described herein, a quantity of antenna panels for use within performance of the SDT may be selected based on the reference signal received power and selecting the first power mode of the set of multiple power modes may be based on the quantity of antenna panels.

In some examples of the method, UEs, and non-transitory computer-readable medium described herein, each power mode of the set of multiple power modes may be associated with a respective MCS threshold, a respective PDCCH code rate threshold, a respective quantity of antenna panels, a respective synthesizer, a respective PDCCH power consumption metric, a respective physical downlink shared channel (PDSCH) power consumption metric, or any combination thereof.

In some examples of the method, UEs, and non-transitory computer-readable medium described herein, the first power mode may be selected based on the first power mode being associated with a minimum power consumption metric of a subset of the set of multiple power modes, the subset of the set of multiple power modes including the first power mode.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support power mode selection for small data transmission in accordance with one or more aspects of the present disclosure.

FIG. 3 shows an example of a flow diagram that supports power mode selection for small data transmission in accordance with one or more aspects of the present disclosure.

FIG. 4 shows an example of a process flow that supports power mode selection for small data transmission in accordance with one or more aspects of the present disclosure.

FIGS. 5 and 6 show block diagrams of devices that support power mode selection for small data transmission in accordance with one or more aspects of the present disclosure.

FIG. 7 shows a block diagram of a communications manager that supports power mode selection for small data transmission in accordance with one or more aspects of the present disclosure.

FIG. 8 shows a diagram of a system including a device that supports power mode selection for small data transmission in accordance with one or more aspects of the present disclosure.

FIGS. 9 and 10 show flowcharts illustrating methods that support power mode selection for small data transmission in accordance with one or more aspects of the present disclosure.

### DETAILED DESCRIPTION

In some wireless communications systems, user equipments (UEs) and network entities may communicate via radio channels. To facilitate such communications, a UE may establish a radio resource control (RRC) connection with a network entity, where the UE may operate in different RRC communication states, such as connected and idle communication states (e.g., RRC_CONNECTED, RRC_IDLE). Accordingly, while operating within the connected state, the UE may communicate data with the network entity. Alternatively, while operating within the idle state, the UE may refrain from sending or receiving data with the network entity and may not maintain an active RRC connection. In some cases, the UE may transition from the idle state to the connected state, thereby re-establishing an RRC connection, based on the UE or network entity having data to be communicated. In such examples, however, transitioning from the idle to connected state may be associated with relatively high latency (e.g., RRC connection establishment timelines) and high signaling overhead.

To reduce such latency, the UE may support a third communication state, such as an inactive communication state (e.g., RRC_INACTIVE), in which the UE may not perform data transmission (e.g., may be dormant), but may not completely release the RRC connection of the connected state (e.g., the NAS layer may remain connected). For example, while operating in the inactive mode, the UE may perform small data transmissions (SDT) for a duration, where within the duration of time, the UE and network entity may communicate a relatively small amount of data (e.g., 32 bytes to 96 kB) without transitioning to the connected state. In such examples, however, as part of the SDT, the UE may decode a physical downlink control channel (PDCCH) received in each slot within the duration, even if data transmission has already occurred, which may result in increased power consumption at the UE, increased signaling overhead, increased latency, among other disadvantages.

The techniques, methods, and devices described herein may provide for a selection of different power modes at a UE to use for SDT, thereby reducing power consumption at the UE during the SDT. For example, the UE may maintain a mapping (e.g., lookup table (LUT)) between power modes and various parameters, such as a modulation and coding scheme (MCS) threshold, a physical downlink control channel (PDCCH) code rate threshold, or both. Accordingly, while operating in the inactive mode, the UE may measure the reference signal received power (RSRP) of a PDCCH. If the RSRP satisfies a threshold, the UE may transmit a physical random-access channel (PRACH) message to the network entity, thereby initiating the SDT. Based on initiating the SDT, the UE may monitor for a PDCCH during the SDT to measure a PDCCH code rate, obtain an MCS index associated with physical downlink shared channel (PDSCH) communications, or both. That is, the UE may obtain (e.g., receive, identify, determine, estimate) an MCS index, a PDCCH code rate, or both based on initiating the SDT and based on monitoring a PDCCH associated with the SDT.

Accordingly, the UE may determine a subset of entries in the mapping that have an MCS threshold that the MCS index satisfies, that have a PDCCH code rate threshold that the PDCCH code rate satisfies, or both. From the identified subset of entries in the mapping, the UE may select the power mode that has the lowest PDCCH power consumption or the lowest PDSCH power consumption. By selecting the power mode for the UE according to the PDCCH code rate, MCS index, among other parameters, the UE may identify and utilize a power mode with relatively less power consumption during the SDT, thereby saving power, extending batter life of the UE, among other advantages.

Aspects of the disclosure are initially described in the context of wireless communications systems, process diagrams, and process flows. Aspects of the disclosure are further illustrated by and described with reference to apparatus diagrams, system diagrams, and flowcharts that relate to power mode selection for SDT.

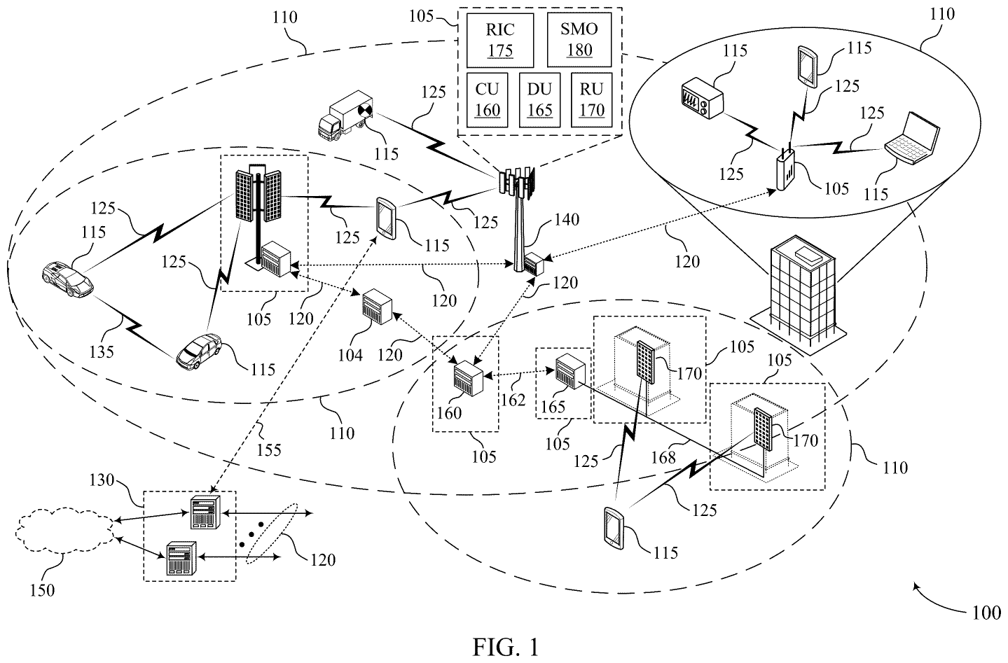

FIG. 1 shows an example of a wireless communications system 100 that supports power mode selection for SDT in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, among other examples, may include disclosure of the UE 115, network entity 105, apparatus, device, computing system, among other examples, being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), cFeMTC (enhanced further eMTC), and mMTC (massive MTC), and NB-IoT may include eNB-IoT (enhanced NB-IoT), and FeNB-IoT (further enhanced NB-IoT).

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems 100 may support UEs 115 operating in different RRC communication states, such as connected and idle communication states (e.g., RRC_CONNECTED, RRC_IDLE). To establish communication, a UE 115 may establish an RRC connection to a serving cell. The RRC communication states may be indicated or controlled by a network entity 105. Accordingly, while operating within the connected state, the UE 115 may communicate data with the network entity 105. Alternatively, while operating within the idle state, the UE 115 may refrain from sending or receiving data with the network entity 105 and may not maintain an active RRC connection. In some cases, the UE 115 may transition from the idle state to the connected state, thereby re-establishing an RRC connection, based on the UE 115 or network entity 105 having data to be communicated. In such examples, however, transitioning from the idle to connected state may be associated with relatively high latency (e.g., RRC connection establishment timelines) and high signaling overhead. For example, in some cases, the UE 115 may have small, frequent chunks of data to transmit (e.g., bursty traffic). In these cases, the UE 115 may frequently (e.g., repeatedly) transition between the connected and idle states, which may result in relatively higher power consumption at the UE, as each transition may involve increased RRC connection establishment timelines and signaling overhead.

Accordingly, the UE 115 may support a third communication state, an inactive communication state (e.g., RRC_INACTIVE), in which the UE 115 may not perform data transmission (e.g., may be dormant), but may not completely release the RRC connection of the connected state (e.g., the NAS layer may remain connected). That is, the inactive state may be a state between the idle and connected states. For example, if there is no traffic, a network entity 105 may transition the UE 115 to the inactive state without completely releasing the RRC connection. From the inactive state, the UE 115 may transition to the connected state to transmit data or when the network entity 105-a may indicate to do so. The transition from the inactive state to the connected state may be associated with less time and overhead than the transition from the idle state to connected state, since the inactive state may not involve a full re-establishment of the connected state. If the UE 115 has data to be transmitted, the UE 115 may use an RRC resume process, which may enable the UE 115 to switch from the inactive state to the connected state and perform a data transmission. This transition may be simpler or more efficient than a transition from the idle state to the connected state. However, in cases of bursty traffic, the UE 115 may transition from the inactive to connected state frequently, which may be inefficient, power consuming, and associated with high signaling overhead.

In some implementations, while operating in the inactive mode, the UE 115 may perform small data transmissions (SDT) for a period of time, where, within the period of time, the UE 115 and network entity 105 may communicate a relatively small amount of data (e.g., 32 bytes to 96 kB) without transitioning to the connected state. This may reduce signaling overhead, as well as provide other benefits. SDT may also be associated with a timer. For example, if the UE 115 does not send a transmission within the timer or the network entity 105 does not indicate for the UE 115 to end an SDT process within the timer, the UE 115 may transition to the inactive state without an SDT process, or to the idle state. In such examples, however, during the SDT, the UE 115 may decode each slot within the period of time, even if data transmission has already occurred, which may result in increased power consumption at the UE 115, increased signaling overhead, increased latency, among other disadvantages.

In some implementations, a UE 115 may select different power modes to use for SDT, thereby reducing power consumption at the UE 115 during the SDT. For example, the UE 115 may maintain a mapping (e.g., LUT) between power modes and various parameters, such as an MCS threshold, a PDCCH code rate threshold, or both. Accordingly, while operating in the inactive mode, the UE 115 may measure the RSRP of a PDCCH. If the RSRP satisfies a threshold, the UE 115 may transmit a PRACH message to the network entity, thereby initiating the SDT. Based on initiating the SDT, the UE 115 may monitor for a PDCCH during the SDT to measure a PDCCH code rate, obtain an MCS index associated with PDSCH communications, or both. Accordingly, the UE 115 may determine a subset of entries in the mapping that have an MCS threshold that the MCS index satisfies, that have a PDCCH code rate threshold that the PDCCH code rate satisfies, or both. From the identified subset of entries in the mapping, the UE 115 may select the power mode that has the lowest PDCCH power consumption or the lowest PDSCH power consumption.

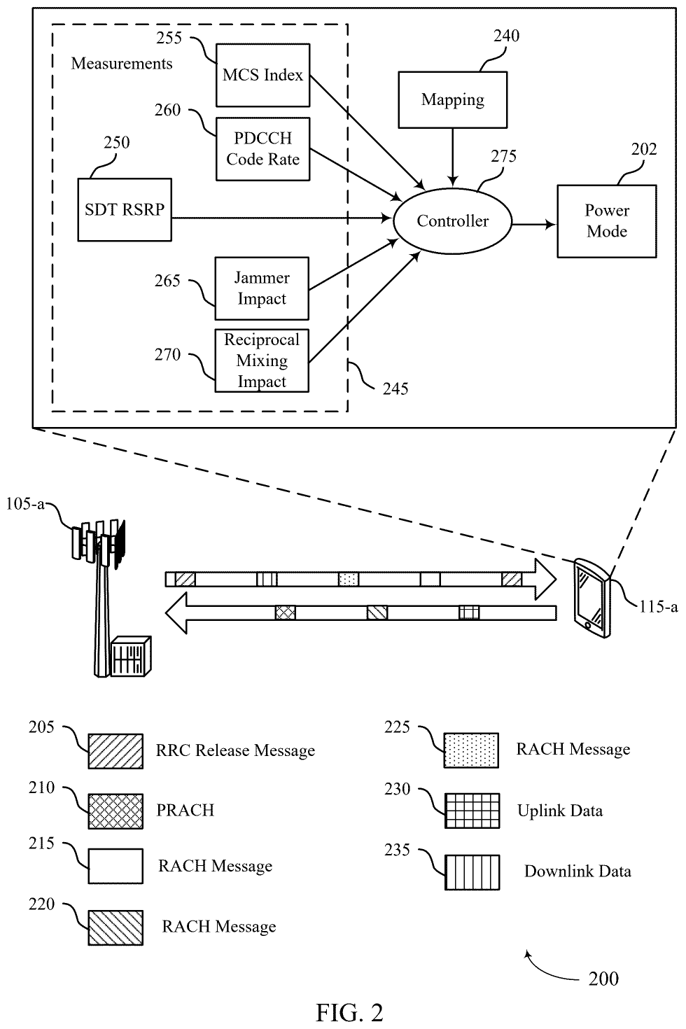

FIG. 2 shows an example of a wireless communications system 200 that supports power mode 202 selection for SDT in accordance with one or more aspects of the present disclosure. For example, the wireless communications system 200 may include a UE 115-a and a network entity 105-a, which may be examples of the corresponding devices as described herein, including with reference to FIG. 1. The techniques described in the context of the wireless communications system 200 may enable the UE 115-a to select a power mode 202 for use during SDT.

Some wireless communications systems may support UEs 115 operating in different RRC communication states, such as connected, inactive, and idle communication states. The inactive state may be a state between the idle and connected states. From the inactive state, the UE 115-a may transition to the connected state to transmit data or when the network entity 105-a may indicate to do so. The transition from the inactive state to the connected state may be associated with less time and overhead than the transition from the idle state to connected state. In cases of bursty traffic (e.g., small, frequent chunks of data), the UE 115-a may transition from the inactive to connected state frequently, which may be inefficient, increase power consumption, and be associated with high signaling overhead.

In some implementations, the UE 115-a may support SDT to avoid the frequent state changes associated with bursty traffic. As part of SDT, the UE 115-a may communicate a small amount of data (e.g., 32 bytes to 96 kB) in the inactive state without transitioning to the connected state (e.g., without any state transition), which may reduce signaling overhead, among other advantages.

To facilitate the SDT, and prior to entering the inactive state, the UE 115-a may receive a system information block (SIB) (e.g., SDT-ConfigCommonSIB information element of the SIB) from the network entity 105-a, where the SIB may indicate an RSRP threshold (e.g., SDT-RSRP-Threshold) to use for initiating SDT, a delay timer for a scheduling request (e.g., SDT-LogicalChannelSR-DelayTimer), a data volume threshold (e.g., SDT-Data VolumeThreshold), an SDT timer within which an SDT process may be completed (e.g., t319a), or any combination thereof. In such examples, the RSRP threshold may be some RSRP range (e.g., RSRP-Range) or a value. The delay timer may be one of a range of values (e.g., a range from 20 fs to 2560 fs). The data volume threshold may be one of a range of different data volumes (e.g., 32 bytes to 960000 byte). The SDT timer may be one of a range of values (e.g., 100 ms to 4000 ms).

Accordingly, the network entity 105-a may transmit an RRC release message 205, where the RRC release message 205 may include a suspend configuration (e.g., SuspendConfig) indicating for the UE 115-a to enter the inactive state. The UE may transition to the inactive state based on receiving the RRC release message 205. While operating in the inactive state, the UE 115-a may measure the RSRP of one or more signals transmitted from the network entity (e.g., a PDCCH) and, if the RSRP satisfies the RSRP threshold (e.g., indicated in the SIB), the UE 115-a may initiate SDT with the network entity 105-a by transmitting a PRACH 210 (e.g., SDT PRACH).

In response, the network entity 105-a may transmit a random-access channel (RACH) message 215 (e.g., Msg2) to the UE 115-a, where the UE may respond to the RACH message 215 by transmitting a RACH message 220 (e.g., Msg3) including an RRC resume request (RRCResumeReq) and uplink data. As such, based on transmitting the RACH message 220, the UE 115-a and the network entity 105-a may start the timer (e.g., t319a) associated with SDT. Based on receiving the RACH message 220, the network entity 105-a may send a RACH message 225 (e.g., Msg4) to the UE 115-a, which may include contention resolution (CR) information.

In such examples, during the duration of the timer, the UE 115-a and the network entity 105-a may perform the SDT. For example, the UE 115-a may transmit uplink data 230 to the network entity 105-a, while the network entity 105-a may transmit downlink data 235 to the UE 115-a. The UE 115-a and the network entity 105-a may terminate the SDT based on expiration of the timer, the RRC release message 205, or both. For example, to terminate the SDT session, the network entity 105-a may transmit an RRC release message 205 with a suspend configuration, to end the SDT. Based on receiving the RRC release message 205, the UE 115-a may transition to the inactive state. As described herein, the UE 115-a and the network entity 105-a may perform a similar process using a two-step RACH process (e.g., UE transmits msg 1 and msg3 in MSGA and network entity 105-a transmits Msg2 and msg4 in MSGB).

As described herein, the UE 115-a and the network entity 105-a may perform the SDTs in (e.g., during or within the duration of) the timer (e.g., t319a). The timer may guard the SDT procedure at the UE 115-a such that, if the network entity 105-a does not terminate or end the SDT procedure within the timer (e.g., by sending an RRC release message 205), the UE 115-a may deactivate the SDT and transition to the inactive state or the idle state. That is, if a UE 115-a does not send a transmission within the timer or the network entity 105-a does not indicate for the UE 115-a to end an SDT process within the timer, the UE 115-a may transition to the inactive state without an SDT process or transition to the idle state.

In such examples, the timer may start based on the UE 115-a transmitting a resume request in the RACH message 220 associated with the RRC resume process (e.g., RRCResumeRequest, RRCResumeRequest1), which may initiate data transmission for the SDT. The timer may stop based on the UE 115-a receiving, in response to the resume request, an RRC resume message (e.g., RRCResume), an RRC setup message (e.g., RRCSetup), an RRC release message (e.g., RRCRelease), or an RRC rejection message (e.g., RRCReject). Additionally, or alternatively, the timer may stop based on (e.g., in response to) failure to resume an RRC connection for SDT or based on cell reselection.

In such examples, while the SDT is ongoing, the UE 115-a may decode a PDCCH in each slot until the network entity 105-a terminates the SDT procedure or the timer expires, even if data transmission has already occurred. That is, the period in which SDT may occur may be continuous, such that the UE 115-a may continually decode each PDCCH within the SDT timer, resulting in increased power consumption at the UE 115-a, increased signaling overhead, increased latency, among other disadvantages. For example, the UE 115-a may decode the PDCCH in each slot to determine whether data is scheduled to be transmitted at the UE 115-a, thereby resulting in increased signaling overhead, increased power consumption, or both.

Such power consumption may be further increased as the UE 115-a may utilize an increased quantity of antenna panels (e.g., antennas, receivers (Rx) for receiving chains) (e.g., 2Rx, 4Rx) the PDCCH. Additionally, or alternatively, during the SDT, the UE 115-a and the network entity 105-a may not support a discontinuous reception (DRX) mechanism, nor support various power reduction features. Although the SDT timer may mitigate some characteristics associated with continuous SDT by putting a limit on the length an SDT process may occur, the length of the timer, which in some cases may be defined within a determined range (e.g., 100 ms to 4 s, such as 2-3.5 second), may be relatively longer, thereby increasing power consumption at the UE 115-a. For example, the length of the timer may be based on a network backhaul latency (e.g., worst-case latency), resulting in the relatively increased timer. Thus, techniques may be desired to reduce power consumption at the UE 115-a during SDT.

The techniques described herein may enable the UE 115-a to determine a power mode 202 for use during the SDT, where the power mode 202 of the UE 115-a may include (e.g., be defined by) a quantity of active antenna panels at the UE 115-a during the SDT, a type of synthesizer utilized by the UE 115-a during the SDT, a phase-locked loop (PLL) of the UE 115-a, or a combination thereof. The UE 115-a may utilize various measurements 245 and/or parameters to identify the power mode 202, where such measurements and parameters may include an SDT RSRP 250 (e.g., SDT-RSRP-Threshold), PDCCH and PDSCH power consumptions, PDCCH and PDSCH decidability, an MCS index 255 (e.g., MCS), PDCCH code rate 260, jammer impact 265, reciprocal mixing impact 270, or a combination thereof.

In some examples, the UE 115-a may maintain a mapping 240 (e.g., a LUT), where the mapping 240 may identify a relationship between various power modes 202 (defined in the mapping 240) and supported MCS indices 255, supported PDCCH code rates 260, one or more power consumption metrics, or a combination thereof. That is, the UE 115-a may be provided (e.g., from the network entity 105-a via control signaling) or may maintain the mapping 240 between power modes 202 and different parameters, such as a quantity of antenna panels, an MCS threshold, a PDCCH code rate threshold, a type of synthesizer, a PDCCH power consumption metric, and a PDSCH power consumption metric, or any combination thereof.

The mapping 240 may be based on a quantity of antenna panels and PLLs at the UE 115-a. For example, if the UE 115-a includes a first quantity of antenna panels and PLLs, the UE 115-a may utilize a first mapping 240. Alternatively, if the UE 115-a includes a second quantity of panels and PLLs, the UE 115-a may utilize a second mapping 240. Accordingly, the mapping 240 may be based on a quantity of possible or usable antenna panels at the UE 115-a.

The UE 115-a may perform one or more measurements 245 to select a power mode 202 using the mapping 240. For example, the UE 115-a may measure the SDT RSRP 250 of a channel between the UE 115-a and the network entity 105-a to initiate the SDT. In such examples, if the UE 115-a supports two antenna panels (e.g., 2Rx), the UE 115-a may initiate the SDT if the SDT RSRP 250 exceeds the RSRP threshold (indicated in the SIB), while if the UE 115-a includes a single antenna panel (e.g., 1Rx), the UE 115-a may initiate the SDT if the SDT RSRP 250 exceeds the RSRP threshold plus one decibel (dB) (e.g., RSRP Threshold+1 dB).

Accordingly, the UE 115-a may determine a quantity of antenna panels of the power mode 202 to use during the SDT based on the SDT RSRP 250. For example, if the UE 115-a includes a capability to operate according to both a single antenna panel (e.g., 1Rx) or multiple antenna panels (e.g., 2+Rx), the UE 115-a may initiate the SDT session with a single antenna panel if the single antenna panel of the UE 115-a obtains a measured SDT RSRP 250 exceeding the RSRP threshold plus 1 dB plus X dBs (e.g., SDT-RSRP-Threshold+1+X dB), where the network entity 105-a may determine (and signal to the UE 115-a) X or, additionally, or alternatively, the UE 115-a may determine X. In such examples, by determining X, the network entity 105-a may gradually increase the MCS index over a nominal MCS during the SDT session (where the network entity 105-a may determine the nominal MCS based on the RSRP threshold). That is, the UE 115-a may determine to use a single antenna panel (e.g., a single receiver, 1Rx) as part of the power mode 202, rather than two antenna panels (e.g., two receivers, 2Rx), if the SDT RSRP 250 (e.g., measured RSRP) exceeds a second RSRP threshold (e.g., threshold+1 dB+X dB).

Additionally, or alternatively, the UE 115 may select a power mode 202 from the mapping 240 based on a PDCCH code rate 260. That is, the UE 115-a may monitor a PDCCH during the SDT and measure (e.g., identify, determine, obtain) a PDCCH code rate 260 associated with the SDT. The UE 115-a may identify one or more candidate power modes 202 from the mapping based on the PDCCH code rate 260 and one or more PDCCH code rate thresholds included in the mapping 240. The PDCCH code rate thresholds in the mapping 240 may indicate the supported PDCCH code rates 260 of each power mode 202, where such PDCCH code rate thresholds indicate a PDCCH code rate 260 with a block error rate (BLER) less than 1%.

In some implementations, the UE 115-a may utilize an MCS index 255 of PDSCHs to select the power mode 202 from the mapping 240. For example, the UE 115 may receive, via the PDCCH, a DCI that schedules a PDSCH and also indicates the MCS index 255 associated with the PDSCH. In such examples, the MCS index 255 may be a metric for determining or checking the sustainability of downlink traffic. The MCS thresholds in the mapping 240 may indicate the supported MCS index 255 (or indices) for a respective power mode 202. For example, in SDT, a 1-layer downlink grant may be scheduled, which may affect the amount and sustainability of downlink traffic and may indicate a different MCS index 255.

In such examples, the MCS thresholds and PDCCH code rate thresholds included in the mapping 240 may be based on (e.g., be a function of) a signal-to-noise ratio (SNR), frequency bands or a type of frequency band, an MCS table, a delay spread, a Doppler frequency, PDCCH control resource set (CORESET) durations, PDCCH interleaving configurations, or any combination thereof.

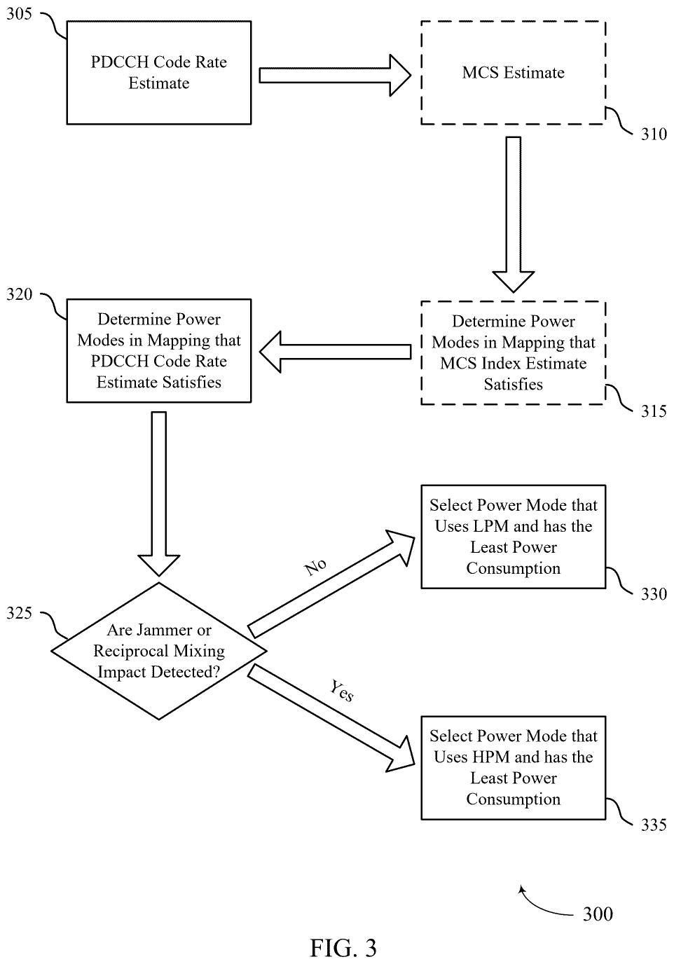

Additionally, or alternatively, power mode 202 selection may be based on the UE 115-a monitoring and detecting jammer impacts 265 and reciprocal mixing impacts 270 in SDT. For example, the UE 115-a may measure interference from an interfering signal (e.g., a jammer) to determine whether the UE 115-a may use a low-performance (LPM) synthesizer or a high-performance (HPM) synthesizer. Techniques for the UE 115-a to monitor for, and detect, jammer impacts 265 and reciprocal mixing impacts 270 may be further described herein with reference to FIG. 3.

The UE 115-a may determine which entries in the mapping 240 satisfy the quantity of antenna panels and type of synthesizer, as well as which entries have an MCS threshold and a PDCCH code rate threshold that the MCS index 255 and PDCCH code rate 260 measurements satisfy. From all entries satisfying these criteria, the UE 115 may select the power mode 202 that has the lowest PDCCH or PDSCH power consumption, depending on an operating mode at the UE 115. The PDSCH power consumption and PDCCH power consumption may be static or fixed values based on the UE 115-a. The UE controller 275 (e.g., ARD APM controller) may utilize the measurements 245 to determine a power mode 202 from the mapping 240, as described further with respect to FIG. 3. An example of such a mapping 240 is shown in Table 1.

TABLE 1
Example of a Mapping 240

| | PDSCH | PDCCH | | PDCCH Code |
|---|---|---|---|---|
| | Power | Power | PDSCH MCS | Rate |
| Power Mode | Consumption | Consumption | Threshold | Threshold |
| 2Rx, HPM Synthesizer | ${PDSCH}_{HPM}^{2 Rx}$ | ${PDCCH}_{HPM}^{2 Rx}$ | — | — |
| 1Rx, HPM Synthesizer | ${PDSCH}_{HPM}^{1 Rx}$ | ${PDCCH}_{HPM}^{1 Rx}$ | 8 | 0.14 |
| 2Rx, LPM Synthesizer | ${PDSCH}_{LPM}^{2 Rx}$ | ${PDCCH}_{LPM}^{2 Rx}$ | 11 | 0.60 |
| 1Rx, LPM Synthesizer | ${PDSCH}_{LPM}^{1 Rx}$ | ${PDCCH}_{LPM}^{1 Rx}$ | 8 | 0.14 |

Table 1 may be an example of a table for PDSCH MCS thresholds and PDCCH code rate thresholds for an SNR of 11 dB, a UE 115-a using an UNA frequency band, the UE 115-a using an MCS table with a first modulation scheme (e.g., a 64QAM MCS table), a timing error tolerance related to a Doppler frequency that is 30 ns at 10 Hz (e.g., TDLA_30 ns_10 Hz), a CORESET duration of 1, and disabled CORESET interleaving. The PDSCH MCS threshold and PDCCH code rate threshold for the top row of Table 1 may be left blank or set to 0 to ensure an increased-performance power mode 202 (e.g., enhanced or best performance mode) to use for the SDT. That is, using two antenna panels (e.g., 2Rx) (for a 2Rx-capable UE 115-a) and an HPM may be the mode that can perform the highest quality transmissions. This mode may also be associated with the highest power consumption and may not be used when the UE 115-a determines it may use fewer antenna panels, the LPM synthesizer, or both. A mapping 240 may contain such a default row to ensure there may be a power mode 202 the UE 115-a may support for SDT.

As an illustrative example, and as described further with reference to FIG. 3, the UE 115-a may transmit, while operating in an RRC inactive mode, the PRACH 210 initiating an SDT between the UE 115-a and a network entity 105-a. The UE 115-a may monitor, based on initiating the SDT, a PDCCH associated with the SDT to identify or estimate the PDCCH code rate 260, the MCS index 255, or both. The UE may perform the one or more communications during the SDT according to the power mode 202, where the power mode 202 may be selected from multiple power modes 202 of the mapping 240 based on the MCS index 255 satisfying an MCS threshold associated with the selected power mode 202, based on the PDCCH code rate 260 satisfying a PDCCH code rate threshold associated with the selected power mode 202, or both. In such examples, to initiate the SDT, the UE 115-a may measure an SDT RSRP 250 of a channel between the UE 115-a and the network entity 105-a serving the UE 115-a, where the power mode 202 may be selected based on the SDT RSRP 250. In some examples, the UE 115-a may also determine a jammer impact 265 and a reciprocal mixing impact 270, where the selected power mode 202 may be selected based on a jammer impact 265 and a reciprocal mixing impact 270.

FIG. 3 shows an example of a flow diagram 300 that supports power mode selection for SDT in accordance with one or more aspects of the present disclosure. For example, the flow diagram 300 may be implemented by a UE, which may be an example of the corresponding devices as described herein, including with reference to FIG. 1. The techniques described in the context of the flow diagram 300 may enable the UE 115 to select a power mode 202 for one or more communications in SDTs.

As described herein with reference to FIG. 2, the UE 115 may initiate SDT if a measured RSRP satisfies an RSRP threshold. In some cases, the UE 115 may determine a quantity of antenna panels (e.g., 1Rx, 2Rx, 4Rx) as part of the power mode based on the measured RSRP. For example, the UE 115 may utilize a single antenna panel (e.g., 1 Rx) if the single antenna panel enables the UE 115 to obtain an RSRP that satisfies (e.g., exceeds) a first RSRP threshold (e.g., SDT-RSRP-Threshold+1+X dB). Alternatively, the UE 115 may determine to use multiple antenna panels (e.g., two or more antenna panels) according to the measured RSRP satisfying a second RSRP threshold (e.g., SDT-RSRP-Threshold)

Based on initiating the SDT (and identifying a quantity of antenna panels), at 305, the UE 115 may estimate a PDCCH code rate. To do so, the UE 115 may estimate (e.g., obtain or identify) the PDCCH code rate by identifying the greatest (e.g., maximum) value between the maximum code rate of a last quantity (NPDCCH) of decoded rates (e.g., N_{PDCCH}=16) and the maximum decoded code rate within a period of time or sliding window of time (T_{PDCCH}) (e.g., T_{PDCCH}=100 ms). For example, the UE 115 may maintain first PDCCH code rates associated with a previous quantity of PDCCHs (e.g., N_{PDCCH}) and also maintain second PDCCH code rates during a sliding window of time (e.g., T_{PDCCH}). As such, the UE 115 may identify a maximum first PDCCH code rate and a maximum second PDCCH code rate and determine the estimated PDCCH code rate (e.g., PDCCH code rate 260) based on the greater of the maximum first PDCCH code rate and the maximum second PDCCH code rate.

In some examples, at 310, the UE 115 may obtain (e.g., estimate, obtain, determine, receive) an MCS index. For example, the UE 115 may obtain (e.g., identify, receive) the MCS index by determining the maximum MCS index for a PDSCH in a period of time or sliding window of time (T_{MCS}) (e.g., T_{MCS}=128 ms). For example, the UE 115 may receive one or more PDCCHs during the period of time (e.g., T_{MCS}), where such PDCCHs schedule a respective PDSCH and indicated an associated MCS. Accordingly, the UE 115 may maintain (in memory) the MCS indices indicated by the PDCCHs during the period of time and set the MCS index (e.g., estimated MCS index) for the SDT based on a maximum of the stored MCS indices.

In such examples, at 310, the UE 115 may estimate the MCS index if the received PDCCH schedules a PDSCH (e.g., via DCI). That is, if the UE 115 receives a downlink grant (e.g., DCI received on the PDCCH) scheduling the PDSCH, the UE 115 may perform the operations at 310 (and assume to be operating in a downlink traffic mode). Alternatively, in some examples, the UE 115 may refrain from performing the operations at 310 in response to the received PDCCH not scheduling a PDSCH (e.g., a PDCCH-only SDT use case). For example, the UE 115 may determine that the network entity 105 is transmitting PDCCHs (and no PDSCHs) if the UE 115 does not receive a downlink grant (e.g., scheduled PDSCH) within a duration of time (T_{PDCCH_only}) (e.g., T_{PDCCH_only}=100 ms). Accordingly, if the UE 115 receives one or more PDCCHs within the duration of time that do not include a downlink grant, the UE 115 may refrain from performing the operations at 310. Alternatively, if the UE 115 receives a downlink grant within the duration of the time, the UE 115 may perform the operations at 310. In such examples, the duration of time (e.g., timer) may be reset after reception of a downlink grant in the PDCCH (e.g., it is a sliding window).

At 315, if the UE 115 has obtained an MCS index at 310, the UE 115 may determine a subset of power modes in the mapping based on the MCS index. For example, the UE 115 may identify one or more first candidate power modes within the mapping based on the MCS index satisfying a respective MCS threshold associated with each candidate power mode. That is, the UE 115 may identify the power modes in the mapping that support a greater MCS index than the estimated MCS index at 310.

At 320, the UE 115 may determine (e.g., identify) a subset of power modes in the mapping based on the PDCCH code rate identified at 305. For example, the UE 115 may identify one or more candidate power modes within the mapping based on the PDCCH code rate satisfying a respective PDCCH code rate threshold associated with each candidate power mode. That is, the UE 115 may identify the power modes in the mapping that support a greater PDCCH code rate than the estimated PDCCH code rate at 305.

In such examples, if the UE 115 performed the operations at 310 and 315, indicating that the UE 115 has identified one or more first candidate power modes associated with the MCS index, the UE 115 may determine one or more second candidate power modes from the one or more first candidate power modes at 315. Alternatively, if the UE 115 skips the operations at 310 and 315, indicating that the UE 115 is operating within the PDCCH-only scenario, the UE 115 may identify the one or more candidate power modes from each of the power modes within the mapping.

At 325, the UE 115 may determine whether jammer impact is detected, whether reciprocal mixing impact is detected, or both. That is, the UE 115 may determine whether there is interference from a jammer degrading the signal quality (e.g., a jammer impact) and whether the signal, after the signal is modified using the LPM synthesizer, and interfering signals are mixing (e.g., a reciprocal mixing impact).

For example, the UE 115 may detect jammer impact if a detected SNR drop (e.g., SNR delta) between a measured LPM synthesizer SNR and the projected SNR from the HPM synthesizer SNR satisfies a threshold. As an illustrative example, the UE 115 may detect jammer impact if the change in the SNR between the LPM synthesizer SNR and the projected SNR from the HPM synthesizer is greater than 9 dB. In such examples, the LPM synthesizer may have a wide phase noise bandwidth compared to the HPM synthesizer, and, as such, the skirt (e.g., the edges) of the effects of the jammer (e.g., down converted out-of-band jammer) may leak into the downlink channel and degrade the received SNR at the UE 115. Accordingly, the UE 115 may use difference between the measured LPM synthesizer SNR and the projected SNR from the HPM synthesizer SNR as a jammer presence indication, as this may indicate an impact from a jammer. In some cases, the UE 115 may use a high threshold for the change in SNR or the SNR drop to accommodate variations in the channel (e.g., a fading channel).

The UE 115 may detect reciprocal mixing impact based on an LPM synthesizer spot phase noise profile, an adjacent interference power, a transmission power, or a combination thereof. That is, the LPM synthesizer may have wide and strong phase nodes, leading to a wide skirt. The LPM synthesizer may down convert the frequency of signals, which may widen the skirt further. A jammer may also have a wide skirt, and this may cause interference between the signals and further degradation of signal quality. In some cases, there may not be a jammer or the interference may be in frequencies that, even when down converted, do not overlap. In these cases, the UE 115 may use the LPM, despite the widened spectrum of the LPM synthesizer or the jammer. In other cases, there may be interference or overlap between the jammer and signal. In these cases, the UE 115 may use the HPM synthesizer.

In some cases, the network entity 105 may transmit one or more reference signals during SDT, such as zero-power channel state information reference signals (ZP-CSI-RS), such that the UE 115 may determine whether jammer impact is detected, determine whether reciprocal mixing impact is detected, or both. For example, the network entity 105 may allocate the one or more ZP-CSI-RSs via broadcast signaling, such as via broadcast SIB signaling. In other cases, the network entity 105 may allocate the one or more ZP-CSI-RSs via a UE-specific suspend configuration, such as the suspend configuration indicated via the RRC release message described in FIG. 2. In such examples, the network entity 105 may allocate a single ZP-CSI-RS during the SDT. Alternatively, the network entity 105 may allocate the ZP-CSI-RS with a periodicity during the SDT.

The UE 115 may utilize the resources allocated for the one or more ZP-CSI-RSs to detect the presence of an interference signal, and to select between the HPM synthesizer and the LPM synthesizer based on a potential impact of jammer reciprocal mixing. For example, the UE 115 may estimate a noise level to determine SNR using the ZP-CSI-RS. In some cases, the UE 115 may enable an LPM synthesizer. With the LPM synthesizer enabled, interference due to the skirt of the jammer (e.g., the down-converted jammer) or reciprocal mixing with adjacent channel interference (ACI) may result in a higher noise level on the ZP-CSI-RS. Jammer impact detection based on a ZP-CSI-RS may be more robust or accurate than jammer impact detection using a variation or drop in SNR because SNR may rely on (e.g., be a function of) both the jammer and channel variation.

At 330, if the UE 115 does not detect jammer or reciprocal mixing impact at 325, the UE 115 may select, from the one or more candidate power modes identified at 320, a power mode associated with an LPM synthesizer and having the lowest PDCCH power consumption, the lowest PDSCH power consumption, or both. For example, if the UE 115 skips the operations at 310 and 315, the UE 115 may select the power mode associated with the LPM synthesizer and with the least PDCCH power consumption (e.g., the lowest PDCCH power consumption metric). Alternatively, if the UE 115 performs the operations at 310 and 315, the UE 115 may select the power mode associated with the LPM synthesizer and having the lowest PDCCH power consumption or PDSCH power consumption (e.g., the lowest PDCCH power consumption metric or the lowest PDSCH power consumption metric), or the lowest combined power consumption.

At 335, if the UE 115 does detect jammer or reciprocal mixing impact at 325, the UE 115 may select, from the one or more candidate power modes identified at 320, a power mode associated with an HPM synthesizer and having the lowest PDCCH power consumption, the lowest PDSCH power consumption, or both. For example, if the UE 115 skips the operations at 310 and 315, the UE 115 may select the power mode associated with the HPM synthesizer and with the least PDCCH power consumption (e.g., the lowest PDCCH power consumption metric). Alternatively, if the UE 115 performs the operations at 310 and 315, the UE 115 may select the power mode associated with the HPM synthesizer and having the lowest PDCCH power consumption or PDSCH power consumption (e.g., the lowest PDCCH power consumption metric or the lowest PDSCH power consumption metric), or the lowest combined power consumption.

The UE 115 may select a power mode for SDT based on various factors or parameters. In some cases, the UE 115 may select a first power mode and channel conditions or parameters may change, such that the UE 115 may select a second power mode based on the change in channel conditions or parameters. For example, if an MCS index is reduced or lowered, the UE 115 may select a new power mode based on the reduction in the MCS in the downlink grants so that the MCS index may be decoded with one antenna panel enabled, which may be associated with power savings. In another example, the network entity 105 may stop scheduling downlink grants and the UE 115 may select a power mode with less power consumption based on the network entity 105 not scheduling downlink grants.

In some examples, as described herein, the UE 115-a may dynamically switch between power modes for respective communications within the SDT session. For example, the UE 115-a may receive and decode a first PDCCH scheduling a first PDSCH and determine a first PDCCH code rate, a first MCS index, or both based on receiving the first PDCCH. Accordingly, the UE 115-a may perform the operations of the flow diagram 300 to determine a first power mode associated with receiving the first PDSCH. Accordingly, the UE 115-a may receive and decode a second PDCCH scheduling a second PDSCH and determine a second PDCCH code rate, a second MCS index, or both based on the second PDCCH. The UE 115-a may perform the operations of the flow diagram 300 to determine a second power mode associated with receiving the second PDSHC. In this way, the UE 115-a may dynamically switch between power modes during the SDT session.

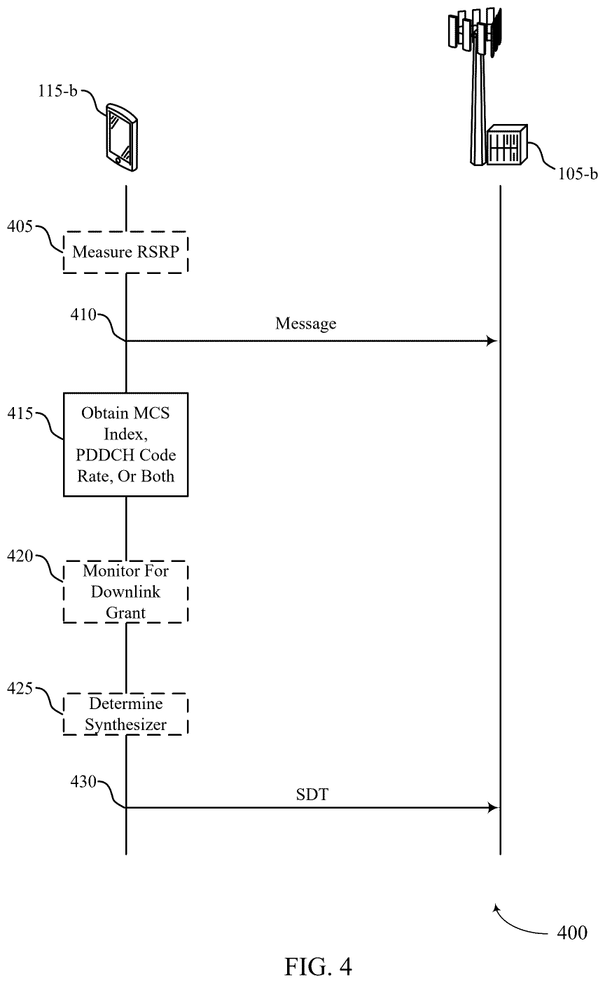

FIG. 4 shows an example of a process flow 400 that supports power mode selection for SDT in accordance with one or more aspects of the present disclosure. The process flow 400 may implement or be implemented to realize aspects of the wireless communications system 100, the wireless communications system 200, and the flow diagram 300. For example, the process flow 400 illustrates communication between a UE 115-b and a network entity 105-b, which may be examples of corresponding devices described herein, including with reference to FIG. 1 and FIG. 2. The process flow 400 may support the UE 115-b selecting a power mode to use for SDT.

At 405, the UE 115-b may measure an RSRP of a channel between the UE 115-b and the network entity 105-b serving the UE 115-b. At 410, the UE 115-b may transmit, while operating in an RRC inactive mode, a message (e.g., first message) initiating an SDT between the UE 115-b and the network entity 105-b. In some implementations, the UE 115-b may transmit the message based on the RSRP of the channel satisfying an RSRP threshold. The network entity 105-b may obtain the message, which may indicate that the UE 115-b measured an RSRP that satisfied the RSRP threshold.

At 415, the UE 115-b may obtain (e.g., identify, determine) an MCS index, a PDCCH code rate, or both based on initiating the SDT. as described further at 410, and based on monitoring a PDCCH associated with the SDT. That is, the UE 115-b may monitor, based on initiating the SDT, a PDCCH associated with the SDT to identify an MCS index, a PDCCH code rate, or both. In some implementations, at 420, the UE 115-b may monitor for a downlink grant within a duration of a timer associated with reception of the PDCCH, as further described herein with reference to the operations at 310 and 315 of FIG. 3.

In some implementations, at 425, the UE 115-b may determine one of an HPM synthesizer or an LPM synthesizer to use for the SDT based on whether reciprocal mixing is detected at the UE 115-b, based on whether jamming at the UE is detected, or both. In some cases, the HPM synthesizer may be used for the SDT based on the reciprocal mixing being detected at the UE, based on the jamming being detected at the UE 115-b, or both. In other cases, the LPM synthesizer may be used for the SDT based on the reciprocal mixing being undetected at the UE 115-b, based on the jamming being undetected at the UE 115-b, or both. In some cases, determining one of the HPM synthesizer or the LPM synthesizer may be based on measuring the ZP-CSI-RS, as described herein with reference to FIG. 3.

At 430, the UE 115-b may perform the SDT according to a first power mode, where the first power mode may be selected from multiple power modes based on the MCS index satisfying a MCS threshold associated with the first power mode, based on the PDCCH code rate satisfying a PDCCH code rate threshold associated with the first power mode, or both. For example, the UE 115-b may select the power mode from the multiple power modes according to the techniques described herein with reference to FIGS. 2 and 3.

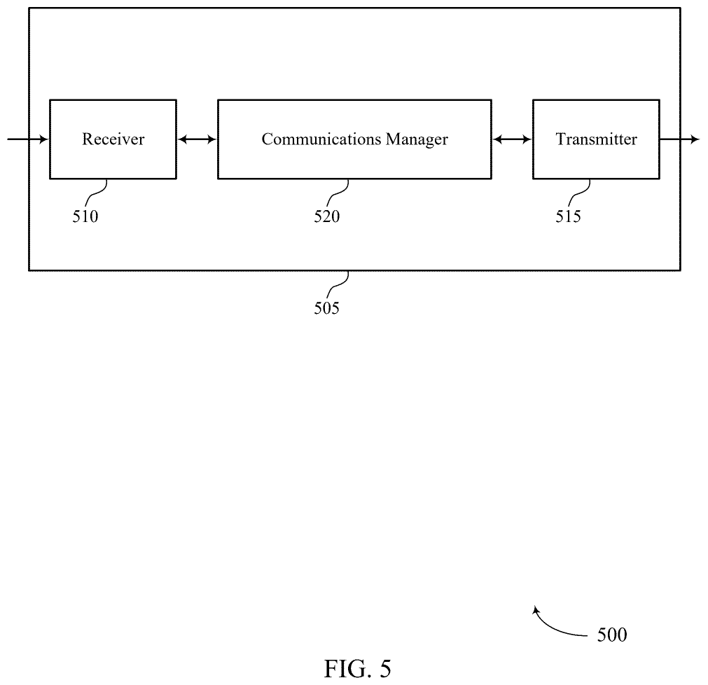

FIG. 5 shows a block diagram 500 of a device 505 that supports power mode selection for SDT in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to power mode selection for SDT). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to power mode selection for SDT). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of power mode selection for SDT as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry) software (e.g., executed by a processor), or any combination thereof. The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, in some examples, the communications manager 520, the receiver 510, the transmitter 515, or various combinations or components thereof may be implemented in code (e.g., as communications management software) executed by at least one processor. If implemented in code executed by at least one processor, the functions of the communications manager 520, the receiver 510, the transmitter 515, or various combinations or components thereof may be performed by a general-purpose processor, a DSP, a CPU, a graphics processing unit (GPU), a neural processing unit (NPU), an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting, while operating in an RRC inactive mode, a first message initiating an SDT between the UE and a network entity. The communications manager 520 is capable of, configured to, or operable to support a means for monitoring, based on initiating the SDT, a PDCCH associated with the SDT to obtain an MCS index, a PDCCH code rate, or both. The communications manager 520 is capable of, configured to, or operable to support a means for performing the SDT according to a first power mode, where the first power mode is selected from a plurality of power modes based on the MCS index satisfying a MCS threshold associated with the first power mode, based on the PDCCH code rate satisfying a PDCCH code rate threshold associated with the first power mode, or both.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

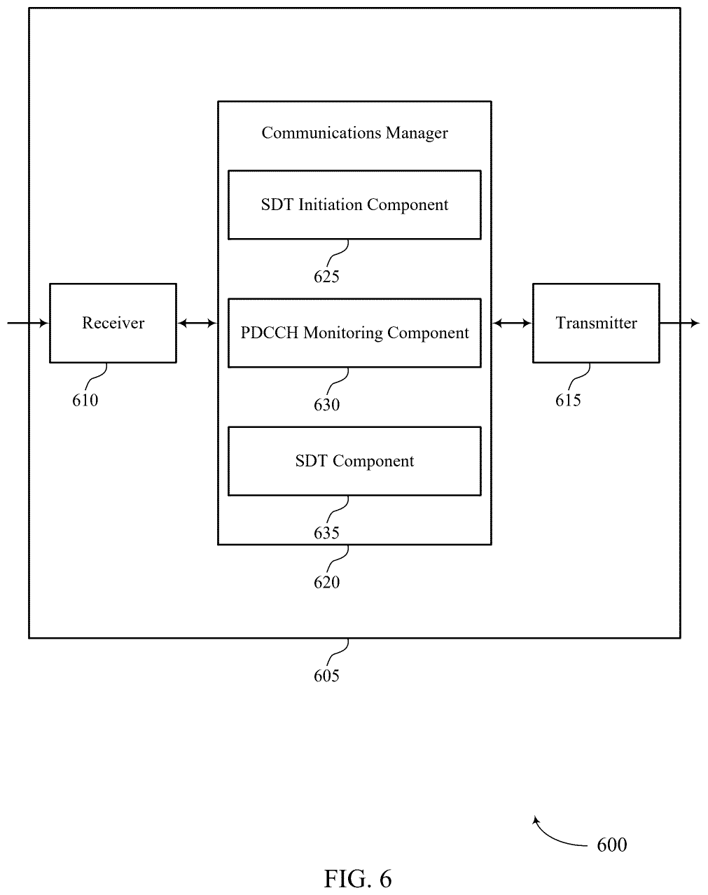

FIG. 6 shows a block diagram 600 of a device 605 that supports power mode selection for SDT in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to power mode selection for SDT). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to power mode selection for SDT). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of power mode selection for SDT as described herein. For example, the communications manager 620 may include an SDT initiation component 625, a PDCCH monitoring component 630, an SDT component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The SDT initiation component 625 is capable of, configured to, or operable to support a means for transmitting, while operating in an RRC inactive mode, a first message initiating an SDT between the UE and a network entity. The PDCCH monitoring component 630 is capable of, configured to, or operable to support a means for monitoring, based on initiating the SDT, a PDCCH associated with the SDT to obtain an MCS index, a PDCCH code rate, or both. The SDT component 635 is capable of, configured to, or operable to support a means for performing the SD according to a first power mode, where the first power mode is selected from a set of multiple power modes based on the MCS index satisfying a MCS threshold associated with the first power mode, based on the PDCCH code rate satisfying a PDCCH code rate threshold associated with the first power mode, or both.

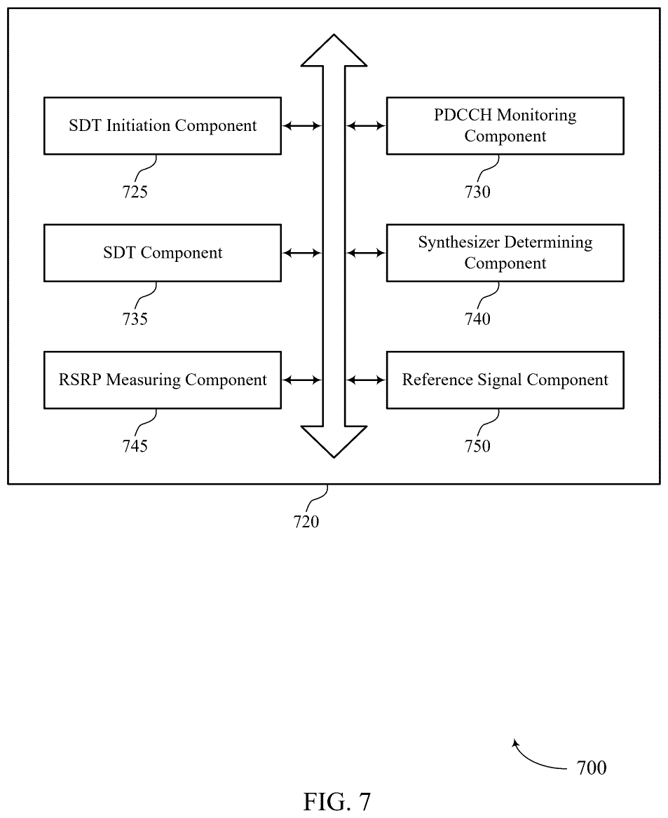

FIG. 7 shows a block diagram 700 of a communications manager 720 that supports power mode selection for SDT in accordance with one or more aspects of the present disclosure. The communications manager 720 may be an example of aspects of a communications manager 520, a communications manager 620, or both, as described herein. The communications manager 720, or various components thereof, may be an example of means for performing various aspects of power mode selection for SDT as described herein. For example, the communications manager 720 may include an SDT initiation component 725, a PDCCH monitoring component 730, an SDT component 735, a synthesizer determining component 740, an RSRP measuring component 745, a reference signal component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The SDT initiation component 725 is capable of, configured to, or operable to support a means for transmitting, while operating in an RRC inactive mode, a first message initiating an SDT between the UE and a network entity. The PDCCH monitoring component 730 is capable of, configured to, or operable to support a means for monitoring, based on initiating the SDT, a PDCCH associated with the SDT to obtain an MCS index, a PDCCH code rate, or both.

The SDT component 735 is capable of, configured to, or operable to support a means for performing the SDT according to a first power mode, where the first power mode is selected from a set of multiple power modes based on the MCS index satisfying a MCS threshold associated with the first power mode, based on the PDCCH code rate satisfying a PDCCH code rate threshold associated with the first power mode, or both.

In some examples, the PDCCH monitoring component 730 is capable of, configured to, or operable to support a means for monitoring for a downlink grant within a duration of a timer associated with reception of the PDCCH, where the first power mode is selected from the set of multiple power modes based on monitoring for the downlink grant within the duration of the timer.

In some examples, the first power mode is selected from the set of multiple power modes according to the PDCCH code rate based on failing to receive the downlink grant within the duration of the timer.

In some examples, the first power mode is selected from the set of multiple power modes according to the PDCCH code rate and the MCS index based on receiving the downlink grant within the duration of the timer.

In some examples, the synthesizer determining component 740 is capable of, configured to, or operable to support a means for determining one of an HPM synthesizer or an LPM synthesizer to use for the SDT based on whether reciprocal mixing is detected at the UE, based on whether jamming at the UE is detected, or both, where the first power mode is selected based on the determination.

In some examples, the HPM synthesizer is used for the SDT based on the reciprocal mixing being detected at the UE, based on the jamming being detected at the UE, or both.

In some examples, the LPM synthesizer is used for the SDT based on the reciprocal mixing being undetected at the UE, based on the jamming being undetected at the UE, or both.

In some examples, the reference signal component 750 is capable of, configured to, or operable to support a means for receiving control signaling allocating a ZP-CSI-RS within a window associated with the SDT, where determining one of the HPM synthesizer or the LPM synthesizer is based on measuring the ZP-CSI-RS.

In some examples, the control signaling indicates a periodicity of the ZP-CSI-RS within the window associated with the SDT.

In some examples, the RSRP measuring component 745 is capable of, configured to, or operable to support a means for measuring an RSRP of a channel between the UE and the network entity serving the UE, where transmitting the first message is based on the RSRP of the channel satisfying an RSRP threshold.

In some examples, a quantity of antenna panels for use within performance of the SDT is selected based on the RSRP. In some examples, selecting the first power mode of the set of multiple power modes is based on the quantity of antenna panels.

In some examples, each power mode of the set of multiple power modes is associated with a respective MCS threshold, a respective PDCCH code rate threshold, a respective quantity of antenna panels, a respective synthesizer, a respective PDCCH power consumption metric, a respective PDSCH power consumption metric, or any combination thereof.

In some examples, the first power mode is selected based on the first power mode being associated with a minimum power consumption metric of a subset of the set of multiple power modes, the subset of the set of multiple power modes including the first power mode.

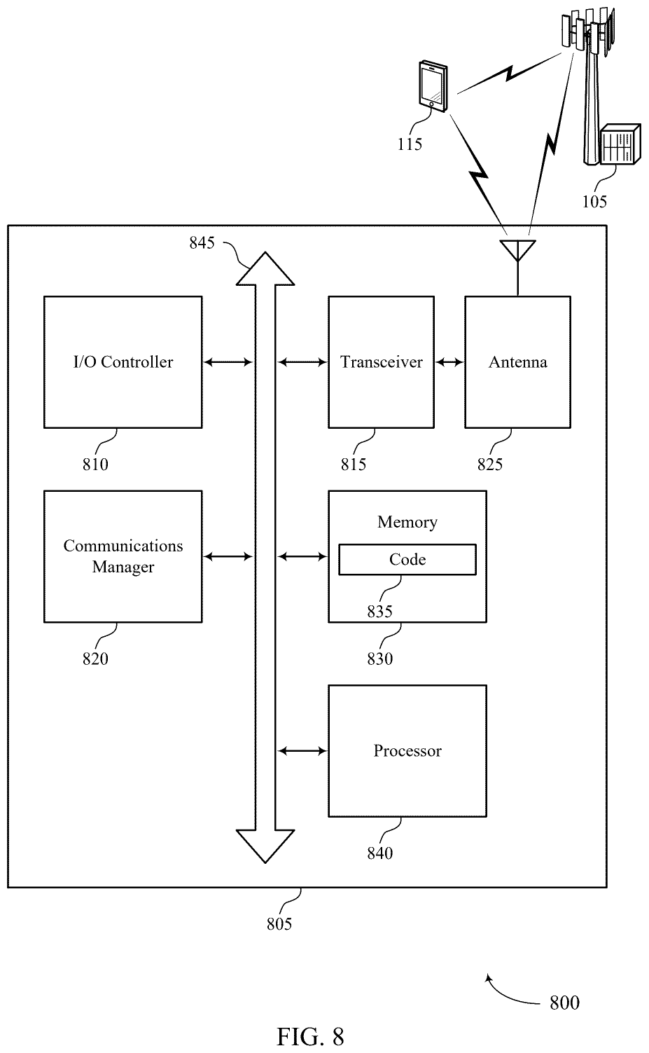

FIG. 8 shows a diagram of a system 800 including a device 805 that supports power mode selection for SDT in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting power mode selection for SDT). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting, while operating in an RRC inactive mode, a first message initiating an SDT between the UE and a network entity. The communications manager 820 is capable of, configured to, or operable to support a means for monitoring, based on initiating the SDT, a PDCCH associated with the SDT to obtain an MCS index, a PDCCH code rate, or both. The communications manager 820 is capable of, configured to, or operable to support a means for performing the SDT according to a first power mode, where the first power mode is selected from a set of multiple power modes based on the MCS index satisfying a MCS threshold associated with the first power mode, based on the PDCCH code rate satisfying a PDCCH code rate threshold associated with the first power mode, or both.

By including or configuring the communications manager 820 in accordance with examples as described herein, the device 805 may support techniques for reduced latency, reduced power consumption, more efficient utilization of communication resources, and longer battery life.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of power mode selection for SDT as described herein, or the at least one processor 840 and the at least one memory 830 may be otherwise configured to, individually or collectively, perform or support such operations.

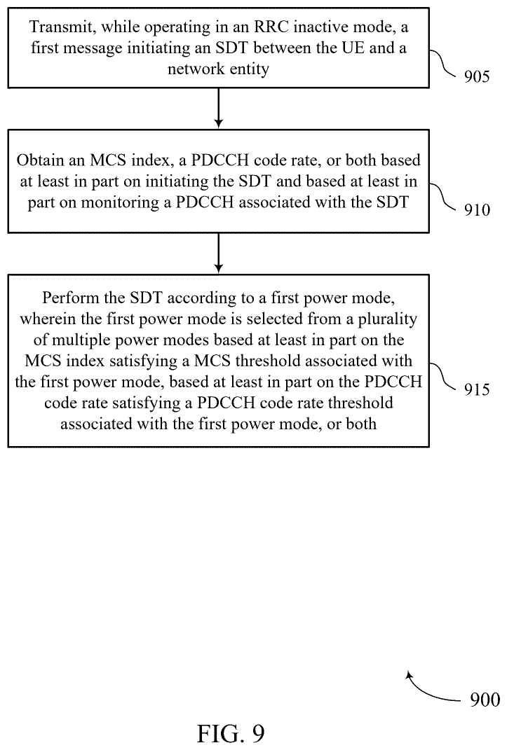

FIG. 9 shows a flowchart illustrating a method 900 that supports power mode selection for SDT in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may comprise transmitting, while operating in an RRC inactive mode, a first message initiating an SDT between the UE and a network entity. The operations of 905 may be performed in accordance with examples as disclosed herein. In some examples, aspects of the operations of 905 may be performed by an SDT initiation component 725 as described with reference to FIG. 7.

At 910, the method may comprise obtaining an MCS index, a PDCCH code rate, or both based at least in part on initiating the SDT and based at least in part on monitoring a PDCCH associated with the SDT. The operations of 910 may be performed in accordance with examples as disclosed herein. In some examples, aspects of the operations of 910 may be performed by a PDCCH monitoring component 730 as described with reference to FIG. 7.

At 915, the method may comprise performing the SDT according to a first power mode, wherein the first power mode is selected from a plurality of power modes based at least in part on the MCS index satisfying a MCS threshold associated with the first power mode, based at least in part on the PDCCH code rate satisfying a PDCCH code rate threshold associated with the first power mode, or both. The operations of 915 may be performed in accordance with examples as disclosed herein. In some examples, aspects of the operations of 915 may be performed by an SDT component 735 as described with reference to FIG. 7.

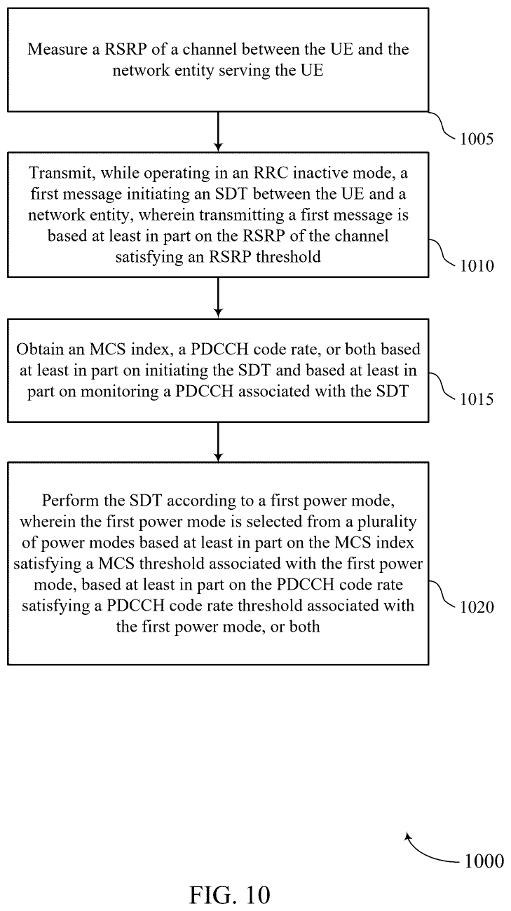

FIG. 10 shows a flowchart illustrating a method 1000 that supports power mode selection for SDT in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may comprise measuring a RSRP of a channel between the UE and the network entity serving the UE. The operations of 1005 may be performed in accordance with examples as disclosed herein. In some examples, aspects of the operations of 1005 may be performed by an RSRP measuring component 745 as described with reference to FIG. 7.

At 1010, the method may comprise transmitting, while operating in an RRC inactive mode, a first message initiating an SDT between the UE and a network entity, wherein transmitting the first message is based at least in part on the RSRP of the channel satisfying an RSRP threshold. The operations of 1010 may be performed in accordance with examples as disclosed herein. In some examples, aspects of the operations of 1010 may be performed by an SDT initiation component 725 as described with reference to FIG. 7.

At 1015, the method may comprise obtaining an MCS index, a PDCCH code rate, or both based at least in part on initiating the SDT and based at least in part on monitoring a PDCCH associated with the SDT. The operations of 1015 may be performed in accordance with examples as disclosed herein. In some examples, aspects of the operations of 1015 may be performed by a PDCCH monitoring component 730 as described with reference to FIG. 7.

At 1020 the method may comprise performing the SDT according to a first power mode, wherein the first power mode is selected from a plurality of power modes based at least in part on the MCS index satisfying a MCS threshold associated with the first power mode, based at least in part on the PDCCH code rate satisfying a PDCCH code rate threshold associated with the first power mode, or both. The operations of 1020 may be performed in accordance with examples as disclosed herein. In some examples, aspects of the operations of 1020 may be performed by an SDT component 735 as described with reference to FIG. 7.

The following provides an overview of aspects of the present disclosure:
Aspect 1: A method for wireless communications at a UE, comprising: transmitting, while operating in an RRC inactive mode, a first message initiating an SDT between the UE and a network entity; obtaining an MCS index, a PDCCH code rate, or both based at least in part on initiating the SDT and based at least in part on monitoring a PDCCH associated with the SDT; and performing the SDT according to a first power mode, wherein the first power mode is selected from a plurality of power modes based at least in part on the MCS index satisfying a MCS threshold associated with the first power mode, based at least in part on the PDCCH code rate satisfying a PDCCH code rate threshold associated with the first power mode, or both.
Aspect 2: The method of aspect 1, further comprising: monitoring for a downlink grant within a duration of a timer associated with reception of the PDCCH, wherein the first power mode is selected from the plurality of power modes based at least in part on monitoring for the downlink grant within the duration of the timer.
Aspect 3: The method of aspect 2, wherein the first power mode is selected from the plurality of power modes according to the PDCCH code rate based at least in part on failing to receive the downlink grant within the duration of the timer.
Aspect 4: The method of any of aspects 2 through 3, wherein the first power mode is selected from the plurality of power modes according to the PDCCH code rate and the MCS index based at least in part on receiving the downlink grant within the duration of the timer.
Aspect 5: The method of any of aspects 1 through 4, further comprising: determining one of an HPM synthesizer or an LPM synthesizer to use for the SDT based at least in part on whether reciprocal mixing is detected at the UE, based at least in part on whether jamming at the UE is detected, or both, wherein the first power mode is selected based at least in part on the determination.
Aspect 6: The method of aspect 5, wherein the HPM synthesizer is used for the SDT based at least in part on the reciprocal mixing being detected at the UE, based at least in part on the jamming being detected at the UE, or both.
Aspect 7: The method of any of aspects 5 through 6, the LPM synthesizer is used for the SDT based at least in part on the reciprocal mixing being undetected at the UE, based at least in part on the jamming being undetected at the UE, or both.
Aspect 8: The method of any of aspects 5 through 7, further comprising: receiving control signaling allocating a ZP-CSI-RS within a window associated with the SDT, wherein determining one of the HPM synthesizer or the LPM synthesizer is based at least in part on measuring the ZP-CSI-RS.
Aspect 9: The method of aspect 8, herein the control signaling indicates a periodicity of the ZP-CSI-RS within the window associated with the SDT.
Aspect 10: The method of any of aspects 1 through 9, further comprising: measuring a reference signal received power of a channel between the UE and the network entity serving the UE, wherein transmitting the first message is based at least in part on the reference signal received power of the channel satisfying a reference signal received power threshold.
Aspect 11: The method of aspect 10, wherein a quantity of antenna panels for use within performance of the SDT is selected based at least in part on the reference signal received power, and selecting the first power mode of the plurality of power modes is based at least in part on the quantity of antenna panels.
Aspect 12: The method of any of aspects 1 through 11, wherein each power mode of the plurality of power modes is associated with a respective MCS threshold, a respective PDCCH code rate threshold, a respective quantity of antenna panels, a respective synthesizer, a respective PDCCH power consumption metric, a respective PDSCH power consumption metric, or any combination thereof.
Aspect 13: The method of any of aspects 1 through 12, wherein the first power mode is selected based at least in part on the first power mode being associated with a minimum power consumption metric of a subset of the plurality of power modes, the subset of the plurality of power modes including the first power mode.
Aspect 14: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 13.
Aspect 15: A UE for wireless communications, comprising at least one means for performing a method of any of aspects 1 through 13.
Aspect 16: A non-transitory computer-readable medium storing code for wireless communications, the code comprising instructions executable by one or more processors (e.g., directly, indirectly, after pre-processing, without pre-processing) to perform a method of any of aspects 1 through 13.

It should be noted that the methods described herein describe possible implementations. The operations and the steps may be rearranged, or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, while operating in a radio resource control (RRC) inactive mode, a first message initiating a small data transmission between the UE and a network entity;
obtain a modulation and coding scheme (MCS) index, a physical downlink control channel (PDCCH) code rate, or both based at least in part on initiating the small data transmission and based at least in part on monitoring a PDCCH associated with the small data transmission; and
perform the small data transmission according to a first power mode, wherein the first power mode is selected from a plurality of power modes based at least in part on the MCS index satisfying a MCS threshold associated with the first power mode, based at least in part on the PDCCH code rate satisfying a PDCCH code rate threshold associated with the first power mode, or both.

2. The UE of claim 1, wherein the one or more processors are individually or collectively further operable to execute the code to cause the UE to:
monitor for a downlink grant within a duration of a timer associated with reception of the PDCCH, wherein the first power mode is selected from the plurality of power modes based at least in part on monitoring for the downlink grant within the duration of the timer.

3. The UE of claim 2, wherein the first power mode is selected from the plurality of power modes according to the PDCCH code rate based at least in part on failing to receive the downlink grant within the duration of the timer.

4. The UE of claim 2, wherein the first power mode is selected from the plurality of power modes according to the PDCCH code rate and the MCS index based at least in part on receiving the downlink grant within the duration of the timer.

5. The UE of claim 1, wherein the one or more processors are individually or collectively further operable to execute the code to cause the UE to:
determine one of a high-performance synthesizer or a low-performance synthesizer to use for the small data transmission based at least in part on whether reciprocal mixing is detected at the UE, based at least in part on whether jamming at the UE is detected, or both, wherein the first power mode is selected based at least in part on the determination.

6. The UE of claim 5, wherein the high-performance synthesizer is used for the small data transmission based at least in part on the reciprocal mixing being detected at the UE, based at least in part on the jamming being detected at the UE, or both.

7. The UE of claim 5, wherein the low-performance synthesizer is used for the small data transmission based at least in part on the reciprocal mixing being undetected at the UE, based at least in part on the jamming being undetected at the UE, or both.

8. The UE of claim 5, wherein the one or more processors are individually or collectively further operable to execute the code to cause the UE to:
receive control signaling allocating a zero-power channel state information reference signal (ZP-CSI-RS) within a window associated with the small data transmission, wherein determining one of the high-performance synthesizer or the low-performance synthesizer is based at least in part on measuring the ZP-CSI-RS.

9. The UE of claim 8, wherein the control signaling indicates a periodicity of the ZP-CSI-RS within the window associated with the small data transmission.

10. The UE of claim 1, wherein the one or more processors are individually or collectively further operable to execute the code to cause the UE to:
measure a reference signal received power of a channel between the UE and the network entity serving the UE, wherein transmitting the first message is based at least in part on the reference signal received power of the channel satisfying a reference signal received power threshold.

11. The UE of claim 10, wherein a quantity of antenna panels for use within performance of the small data transmission is selected based at least in part on the reference signal received power, and wherein selecting the first power mode of the plurality of power modes is based at least in part on the quantity of antenna panels.

12. The UE of claim 1, wherein each power mode of the plurality of power modes is associated with a respective MCS threshold, a respective PDCCH code rate threshold, a respective quantity of antenna panels, a respective synthesizer, a respective PDCCH power consumption metric, a respective physical downlink shared channel (PDSCH) power consumption metric, or any combination thereof.

13. The UE of claim 1, wherein the first power mode is selected based at least in part on the first power mode being associated with a minimum power consumption metric of a subset of the plurality of power modes, the subset of the plurality of power modes including the first power mode.

14. A method for wireless communications at a user equipment (UE), comprising:
transmitting, while operating in a radio resource control (RRC) inactive mode, a first message initiating a small data transmission between the UE and a network entity;
obtaining a modulation and coding scheme (MCS) index, a physical downlink control channel (PDCCH) code rate, or both based at least in part on initiating the small data transmission and based at least in part on monitoring a PDCCH associated with the small data transmission; and
performing the small data transmission according to a first power mode, wherein the first power mode is selected from a plurality of power modes based at least in part on the MCS index satisfying a MCS threshold associated with the first power mode, based at least in part on the PDCCH code rate satisfying a PDCCH code rate threshold associated with the first power mode, or both.

15. The method of claim 14, further comprising:
monitoring for a downlink grant within a duration of a timer associated with reception of the PDCCH, wherein the first power mode is selected from the plurality of power modes based at least in part on monitoring for the downlink grant within the duration of the timer.

16. The method of claim 14, further comprising:
determining one of a high-performance synthesizer or a low-performance synthesizer to use for the small data transmission based at least in part on whether reciprocal mixing is detected at the UE, based at least in part on whether jamming at the UE is detected, or both, wherein the first power mode is selected based at least in part on the determination.

17. The method of claim 14, further comprising:
measuring a reference signal received power of a channel between the UE and the network entity serving the UE, wherein transmitting the first message is based at least in part on the reference signal received power of the channel satisfying a reference signal received power threshold.

18. The method of claim 14, wherein each power mode of the plurality of power modes is associated with a respective MCS threshold, a respective PDCCH code rate threshold, a respective quantity of antenna panels, a respective synthesizer, a respective PDCCH power consumption metric, a respective physical downlink shared channel (PDSCH) power consumption metric, or any combination thereof.

19. The method of claim 14, wherein the first power mode is selected based at least in part on the first power mode being associated with a minimum power consumption metric of a subset of the plurality of power modes, the subset of the plurality of power modes including the first power mode.

20. A non-transitory computer-readable medium storing code for wireless communications, the code comprising instructions executable by at least one processor to:
transmit, while operating in a radio resource control (RRC) inactive mode, a first message initiating a small data transmission between a user equipment (UE) and a network entity;
obtain a modulation and coding scheme (MCS) index, a physical downlink control channel (PDCCH) code rate, or both based at least in part on initiating the small data transmission and based at least in part on monitoring a PDCCH associated with the small data transmission; and
perform the small data transmission according to a first power mode, wherein the first power mode is selected from a plurality of power modes based at least in part on the MCS index satisfying a MCS threshold associated with the first power mode, based at least in part on the PDCCH code rate satisfying a PDCCH code rate threshold associated with the first power mode, or both.
